(19) United States
(12) Patent Application Publication
(10) Pub. No.: US 2009/0101078 A1
(43) Pub. Date: Apr. 23, 2009

(54) Dog Training Device

(76) Inventor: Robert Dobihal, Minnetrista, MN (US)

Correspondence Address: FULBRIGHT & JAWORSKI L.L.P.;Attn: MN IP Docket, 600 Congress Avenue, Suite 2400, Austin, TX, 78701, US

(21) Appl. No.: 11/673,304

(22) Filed: Feb. 9, 2007

Related U.S. Application Data
(60) Provisional application No. 60/772,140, filed on Feb. 9, 2006.

(51) Int. Cl. A01K 29/00

(52) U.S. Cl. 119/707

(57) ABSTRACT

A dog training device and method for training a dog to retrieve a downed fowl. The training device includes a head and a body. The head is moveably connected to the body such that the head moves similar to the way the head of an injured fowl moves. Depending on the configuration, this connection can allow the head to move up and down relative to the body, or it can allow the head to move in all directions. The training device also includes a rope or other device such that a trainer can throw the device into the air for the dog to track and retrieve.

### PRIORITY

This application claims priority benefit of U.S. Provisional Patent Application No. 60/772,140, entitled “DOG TRAINING DEVICE” filed Feb. 9, 2006 the disclosure of which is hereby incorporated herein by reference.

### TECHNICAL FIELD

The present invention relates to dog training devices, and more particularly to devices such as retrieving dummies for use in training dogs to retrieve downed game birds or waterfowl on land or water.

### BACKGROUND OF THE INVENTION

Hunting dogs have long been trained and used for retrieving downed waterfowl. Training typically includes repetitively throwing objects, such as sticks and the like, away from the dog for subsequent retrieval. Home-made or commercially supplied retrieving dummies are also known. As with sticks, such training dummies are of little help in training the dog how best to grasp the downed bird in order to minimize further damage to the skin or tissues of the downed bird.

A number of drawbacks are also associated with commercially available dummies, including the fact that most of them provide an appearance and/or texture that is not life-like. Also, commercially available training dummies do not appear to be designed or intended to be useful for training the dogs to grasp the dummy in a particular manner or location on the dummy. Commercially available dummies which are thrown into the air fail to provide a life-like appearance of an injured bird during descent.

A need therefore exists for a durable life-like training dummy suitable for repeated use. Although the devices presently available have some utility, as with any training exercise or device, it is clear that the techniques and skills associated with training dogs could be significantly improved with the availability of an improved training device according to the present invention.

A need also exists for an accessory item to be purchased separately and used in conjunction with existing training dummies. In one embodiment of the present invention, the head portion of the training device is adapted to be secured to a grommeted end of a commonly available training dummy to provide an improved training device.

### BRIEF SUMMARY OF THE INVENTION

In a preferred embodiment, the present invention provides an improved device for training dogs, the device being provided in the form of a training dummy having a head attachment providing life-like appearance and texture. In addition to providing an anatomically accurate depiction of injured waterfowl or game bird during air born descent, the device of the present invention is durable in the course of repeated, rigorous, and demanding use.

A training device according to the present invention may be assemble using a commonly available training dummy and an accessory head structure secured with a connection structure in accordance with the invention. Alternatively a kit assembly of a training dummy and accessory bird head portion may be sold together. Upon end of life of the training dummy, the head portion may be removed and secured to another training dummy to provide the training device of the present invention.

A training device of the present invention provides an accurate form useful for a young dog to “mark” and identify downed birds during a training program. The head and body portions are preferably flexible and have a tendency to flap during descent in a manner realistically mimicking an injured game bird.

A training device according to the present invention includes a generally cylindrical body portion and head portion. The body portion and head portions are preferably constructed of a suitable durable material that is resistant to the repeated stresses caused by dog's teeth.

In a preferred embodiment a device of the present invention includes a training device having a body portion formed of a fabric material and a head portion formed in a life-like representation of a bird. The length and circumference of the body portion may be dimensioned to be releasably grasped within the mouth of a retrieving dog. The head portion being attached to the body portion and extending away therefrom and configured to represent head of a bird.

The training device is preferably provided in the form of a three-dimensional, life-like, waterproof, buoyant, and reusable device. In one embodiment the training device further comprises a rope traversing an aperture of the head region, the rope being of sufficient length to exit the aperture at the head region and serve as handle of sufficient dimension to be grasped by a trainer in order to toss the training device.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a perspective view of a training device in accordance with a preferred embodiment of the present invention.

FIG. 1B is a perspective view of a training device in accordance with one alternative embodiment of the present invention.

FIG. 2 is a top view of the device in FIG. 1;

FIG. 3 is an exploded perspective view of the training device of FIG. 1; and

FIG. 4 is a cross-sectional view taken through the head portion of the training device of FIG. 1.

### DETAILED DESCRIPTION OF THE INVENTION

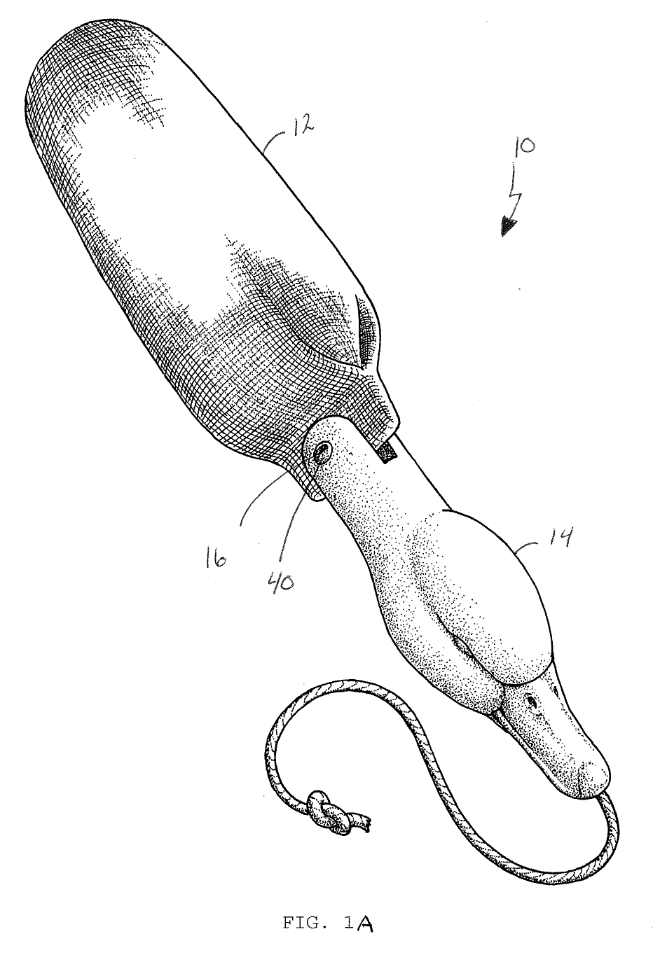

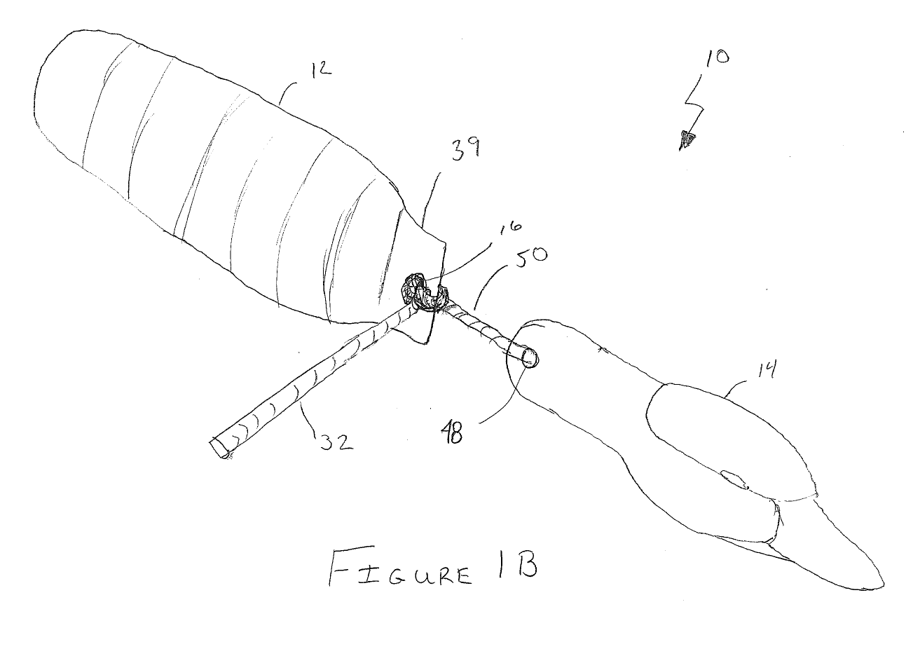

In a preferred embodiment, the present invention provides a three-dimensional, durable, life-like, waterproof, buoyant and reusable retrieving device. Such a preferred device of the present invention will be further described with reference to the drawings, wherein FIG. 1 is a perspective view of an assembled and ready-to-use device in the form of a training device 10.

In FIG. 1, device 10 is shown comprising a body portion 12 and a head portion 14. The body portion 12 of device 10 may also include a pair of wing portions attached to and extending from the body portion, such as disclosed in applicant's copending Provisional Patent Ser. No. 60/675,701, filed Apr. 27, 2005, now U.S. patent application Ser. No. 11/414,520 filed Apr. 27, 2006, and incorporated by reference herein for all purposes. In a preferred embodiment, the body portion 12 is manufactured from canvas or another heavy fabric material. In a preferred embodiment, the various fabric elements are sewn together to form the body of device 10. Body portion 12 may be a commercially available training dummy formed in a generally cylindrical shape and having a grommet 16 or other aperture defined on one end and through which a rope or cord can be secured. Many of these training dummies have been manufactured from canvas and include an interior stuffing material. Other available versions have be molded and/or formed from a single composite. A variety of different commercially available training dummies may be utilized as the body portion 12 of the present invention.

In an illustrated embodiment, body portion 12 is generally cylindrical in form and includes a pair of closed ends. Body portion 12 may include a stuffing material, such as cotton or polymer fibers or foam contained therewithin. The stuffing materials may include an elongated structure having a cavity extending in a longitudinal direction into which a movable ball or other element is received. In this manner, the movable ball or other element is able to move within the cavity during descent in order to create an erratic or unstable movement of the training device during descent. A movable element may include one or more separate elements such as ball, etc. A movable element may be metal, plastic, stone, etc.

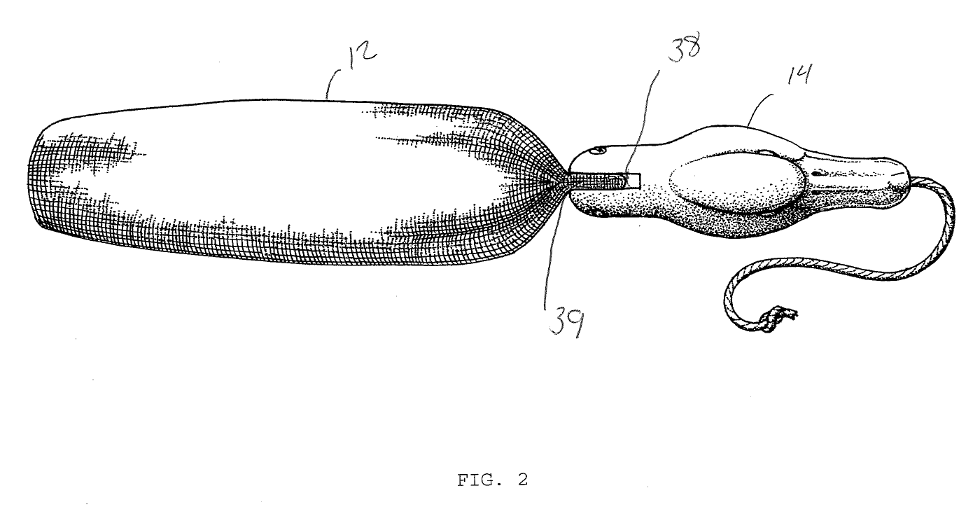

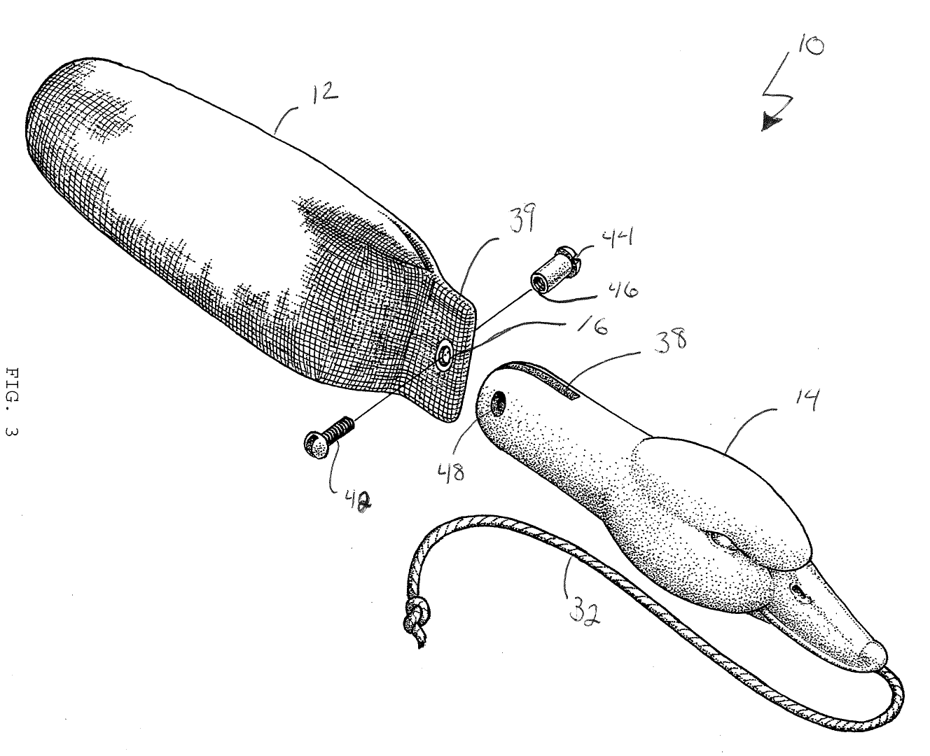

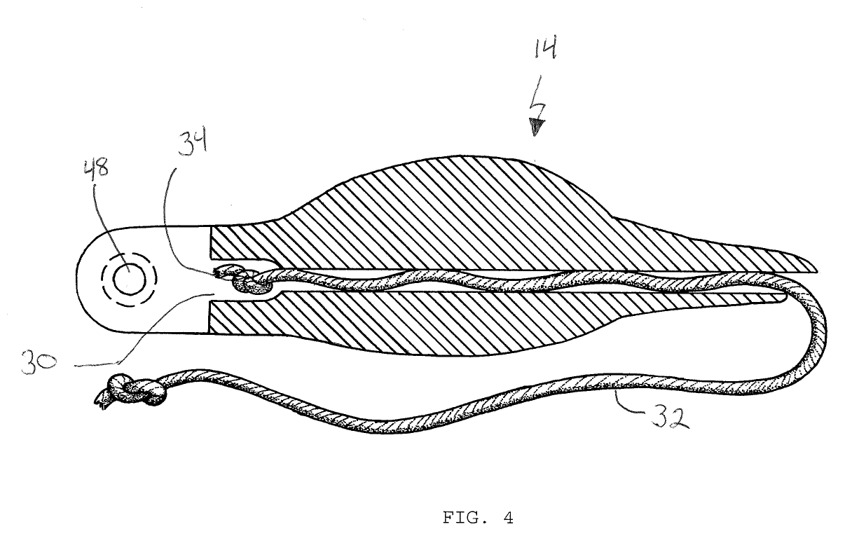

Referring to FIGS. 1-3, in one preferred embodiment of the invention the head portion 14 is a generally life-like, three-dimensional representation of a bird head. Head portion 14 may be a molded part and manufactured, for example, utilizing known injection molding or other molding technologies. As illustrated in FIG. 4, the head portion includes a cavity 30 through which a cord or rope 32 passes. The cavity 30 may include regions of differing dimensions, such as illustrated, so that rope 32 may pass through one portion of the cavity 30 and be secured, by a knot or other enlargement, at a second portion of the cavity 30. In the illustrated embodiment, a knot 34 is formed at one end of the rope 32 and is secured within the cavity 30. As illustrated, the other end of the rope 32 passes through an aperture 33 at a forward end of the head portion 14, i.e., the bill region of the fowl head. In other embodiments, a variety of different rope 32 securing approaches would be practicable. For example, the rope 32 may be secured on the top or bottom surfaces of the head portion 14 away from the forward-most edge. Furthermore, the rope 32 may be secured to the head portion 14 in a variety of different approaches, such as mechanical, thermal and adhesive connections. For example, rope 32 may be crimped within or upon head portion 14 by a deformable mechanical fastener. In another example, rope 32 may be adhered via an adhesive, such as a flexible epoxy or silicon upon or within the head portion 14. Opposite the forward edge of the head portion 14, a slotted structure 38 is defined. Slotted structure 38 is preferably adapted to receive a flattened end portion 39 of body portion 12. Body portion 12 is connected to head portion 14 proximate to the slotted structure 38 via a connection structure, which in this example is a threaded fastener assembly 40.

The connection structure is defined between the head portion 14 and the body portion 12. In the illustrated embodiments, the connection structure includes a threaded fastener 40 sized to be received into and engage portions of the head and body portions 14, 12. Fastener 40 includes male and female components, numbered 42 and 44, respectively. Female component 44 includes a slotted end and an exterior, generally cylindrical surface 46 adapted to engage interior surfaces of an aperture 48 at the end of head portion 14 and surfaces of the grommet 16. In a preferred embodiment, fastener 40 allows generally free movement between the head and body portions 14, 12, so that as the training device falls toward the ground the head and body portions can flutter or flap in a manner at least somewhat representative of an injured bird. The connection structure may assume a variety of different devices or structures, such as rivets, ropes, pins, fabric, adhesives, etc. One illustrative alternative embodiment is shown in FIG. 1B, where the head and body are connected by rope 32 within a neck region 50. In this embodiment the rope can either extend out from the head portion 14 or between the body portion 12 and the head portion 14. In preferred embodiments, the connection structure allows the head and body portions 14, 12 to move relative to each other, preferably in a generally free and unrestrained manner.

In other preferred embodiments of the invention, wing portions can be provided which may be generally flat in comparison to the cylindrical body portion 12. Wing portions can each be defined by a pair of fabric elements which are sewn or joined together utilizing known fabric connecting technologies. Wing portions are preferably easily flexible and flutter during descent of the device 10 to mimic the wings of a compromised waterfowl. Wing portions may include a stiffening element, such as cloth or other fabric, plastic, etc. The wing portions may be generally triangular in form and extend at a rearwardly directed angle relative to the body portion 12. Wing portions may be shorter in length than the overall length of body portion 12. Wing portions can preferably be permanently sewn or joined to body portion 12. In one embodiment, wing portions and body portion 12 are defined by similar fabric elements, such as canvas or another heavy duty fabric. Body portion 12 of the device is preferably unitary, i.e., either formed of or formed into a material that remains substantially intact in the course of repeated use. Such material is also durable in that it is able to withstand the rigors of being repeatedly thrown and retrieved.

Head portion 14 can also be attached to body portion 12 by a flexible cord, rope or other flexible connection. The head portion 14 of a device of the present invention is preferably constructed of a durable material, and positioned on the body portion to provide the drooped appearance of a downed waterfowl. The head is preferably configured to provide the appearance of a drooped waterfowl head, and attached to the body portion in a manner that allows the head to rotate freely in an axis about the central axis of the body, but that nevertheless retains the head in close proximity to the body portion. Head portion 14 may comprised of fabric elements which are sewn together. Head portion 14 may be of an injection molded plastic construction. Head portion 14 may include stuffing materials to provide a life-like three dimensional portrayal of a bird head.

Also disclosed is a method of training a dog comprising the steps of (a) providing a training device as described herein, and (b) throwing the device to a distant location to be retrieved by the dog. Those skilled in the art of training retrieving dogs will, given the present description, appreciate the manner in which devices of the present invention can be used.

In a preferred embodiment, the device is generally thrown a sufficient distance from the dog to be trained, preferably onto the surface of field or body of water. Alternatively, the device 10 may be thrown into a wetland area, containing cattails for example, or into an area covered with brush and/or trees. Head portions 14 or wing portions of the device 10 may be caught upon brush or vegetation so that the device 10 is suspended away from the ground surface. In this regard, a more realistic presentation for training purposes is provided. Generally, the device 10 will be tossed or thrown by the trainer, and the dog provided with a signal to begin to retrieve the dummy. The dog will retrieve the dummy, grasping it in the proper location and manner, and return it to the trainer.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A training device comprising:
a body component;
a head component representative of a head of a fowl, the head component movably coupled to the body component; and
a throwing rope connected to the head component.

2. The training device of claim 1 wherein the throwing rope is connected to a bill region of the head component.

3. The training device of claim 2 wherein the head includes a cavity disposed inside, the cavity holding a portion of the throwing rope; and
wherein the throwing rope extends through the bill region.

4. The training device of claim 1 wherein the head component is coupled to the body component by a threaded fastener assembly.

5. The training device of claim 1 wherein the head component is coupled to the body component by a rope, the rope defining a neck region.

6. The training device of claim 5 wherein the throwing rope is connected to the body portion at the neck region.

7. The training device of claim 5 wherein the throwing rope is connected to the head component at the neck region.

8. The training device of claim 1 wherein the body component is a generally cylindrical body.

9. The training device of claim 8 wherein the body component further comprises a pair of foldable wings.

10. The training device of claim 8 wherein the body component has a diameter such that it fits within a canine mouth.

11. The training device of claim 1 wherein the head component is removably connected to the body component.

12. A method of training a dog to retrieve a downed fowl, comprising:
providing a training device having a head indicative of a fowl, a body connected to the head such that the head and body can flap;
projecting the training device into the air a distance from the dog;
imitating an injured fowl using the training device while the device is in the air; and
having the dog retrieve the training device.

13. The method of claim 12 wherein projecting comprises:
throwing the training device by hand.

14. The method of claim 12 wherein projecting comprises:
throwing the training device by a mechanical means.

15. The method of claim 12 wherein imitating an injured water fowl comprises:
moving the head relative to the body in an up and down motion.

16. The method of claim 15 wherein moving further comprises moving the head relative to the body in a side to side motion.

17. A dog training device comprising:
an imitation fowl head;
a body;
a connecting means connecting the head to the body such that the head can move relative to the body; and
a tossing means for projecting the device.

18. The dog training device of claim 17 wherein the connecting means comprises a threaded fastener that permits movement of the head relative to the body in an up and down direction.

19. The dog training device of claim 17 wherein the connecting means comprises a rope that permits movement of the head in multiple directions relative to the body.

20. The dog training device of claim 17 wherein the tossing means includes a rope handle.

21. The dog training device of claim 20 wherein the rope handle is connected between the fowl head and the body.

22. The dog training device of claim 17 wherein the connecting means and tossing means are defined by rope sections.
